(19) United States
(12) Patent Application Publication
(10) Pub. No.: US 2021/0076853 A1
(43) Pub. Date: Mar. 18, 2021

(54) MEDICAL DEVICE FOR PROTECTION AGAINST HARMFUL GERMS ON SHARED SURFACES

(71) Applicant: Paola Soto, Ambler, PA (US)

(72) Inventor: Paola Soto, Ambler, PA (US)

(21) Appl. No.: 16/995,692

(22) Filed: Aug. 17, 2020

Related U.S. Application Data
(60) Provisional application No. 62/862,030, filed on Jun. 15, 2019.

(51) Int. Cl. A47G 11/00; B64D 11/06; A47G 21/16; D01F 8/14; D01F 8/16; D01F 1/10

(52) U.S. Cl. CPC A47G 11/004; B64D 11/0638; A47G 21/167; D01F 8/14; D10B 2331/10; D01F 1/103; D10B 2101/20; D10B 2331/04; D01F 8/16

(57) ABSTRACT

A medical device to protect against harmful germs on shared surfaces by covering the shared surfaces to isolate the germs from individuals contacting the surfaces. The device may be utilized in public places (e.g., food establishments, classrooms, movie theaters) and public transportation (e.g., planes, trains, bus) to cover trays, desks and/or monitors that may be touched by many individuals. The device may be a system that includes one or more covers where the covers may be reusable, disposable or a combination thereof. The covers may be made from a material or combination of materials that provide at least a subset of stretchable, washable, antibacterial, durable, water-proof/water-resistant and non-slip properties. A reusable cover may include a means for securing the cover to the surface (e.g., draw strings, connectors). A disposable cover may be a film that has clinging properties when stretched.

### PRIORITY

This application claims the priority under 35 USC § 119 of Provisional Application 62/862,030 filed on Jun. 15, 2019, entitled “Forms of Transient Space Health Protection” and having Paola Soto and Adam Simon as inventors. Application 62/862,030 is herein incorporated by reference in its entirety.

### BACKGROUND

Everyday people are exposed to a large variety of germs including bacteria, viruses, fungi, and protozoa. Germs may be transmitted from person to person (e.g., air borne transmission) or may also be transmitted via different surfaces (e.g., contact transmission). For example, many germs can last for hours or even days on different surfaces. Some of the surfaces may be associated with only a small subset of individuals (e.g., home, office) so that the potential transmission of the germs is limited. However, other surfaces may commonly be used by a plurality of individuals each day (e.g., public transportation such as planes, buses, subways and trains; public places such as schools and food establishments). Typically, these surfaces are not cleaned between various individuals using the surfaces. Accordingly, these surfaces could be an easy means for transferring germs from one individual to another. In addition to germs these surfaces may be very dirty and contain all sorts of debris, contaminants and the like.

The transfer of germs may lead to individuals getting sick. The global Corona virus (Covid-19) pandemic of 2020 has heightened the need for limiting the transmission of germs as much as possible. To that end, individuals have been encouraged to wear face masks and possibly face shields and/or gloves, to often clean their hands, to not touch their face and to socially distance. In addition, additional cleaning policies have been implemented for many establishments. For example, tables at restaurants, equipment at hair dressers and gyms, and the like should now be thoroughly cleaned between each use (e.g., seating, hair cut). While the additional cleaning may be possible at some establishments, it may not be feasible for all situations. For example, it may not be feasible to thoroughly clean between each use of a seat on public transportation. The thorough cleanings of planes, trains, buses, subways and taxis may occur at the end of the day. Likewise, it may not be feasible to thoroughly clean desks at, for example, a school between each class.

Individuals may desire to clean the surfaces before they use them. For example, an individual may wish to wipe down a desk or tray before they use it with sanitizing wipes or the like. However, this requires the individual to have sufficient sanitizing wipes for use and also requires the ability to dispose of the wipe after it has been used.

What is needed is an apparatus for shielding the individual from the germs, dirt, contaminants and debris that may be located on different surfaces. This may be particular important for surfaces that an individual may place food or personal equipment on such as a desk, or surfaces that the individual may contact often with their hands such as with touch screens. Particularly, this is important for surfaces that the individual may be in contact with for an extended period of time, such as trays and/or desks that may be used in moveable environments (e.g., airplane, train, bus) or stationary environments (e.g., classrooms, movie theaters, auditoriums, libraries).

### BRIEF DESCRIPTION OF THE DRAWINGS

The features and advantages of the various embodiments will become apparent from the following detailed description in which:

FIGS. 1A-B illustrates an example reusable tray table cover for securing to different size trays, according to one embodiment;

FIG. 2A illustrates a bottom view of an example reusable tray table cover apparatus for securing to a tray, according to one embodiment;

FIG. 2B illustrates a bottom view of the example cover of FIG. 2A secured to a tray that is smaller than the cover, according to one embodiment;

FIG. 3A illustrates an example reusable tray table cover apparatus, according to one embodiment;

FIG. 3B illustrates a bottom view of the cover of FIG. 3A secured to a tray that is smaller than the cover, according to one embodiment;

FIG. 4 illustrates a bottom view of an example cover loop apparatus being placed over a tray, according to one embodiment;

FIGS. 5A-B illustrate top and bottom views of an example disposable tray table cover used on trays larger and smaller than the cover respectively, according to one embodiment; and

FIGS. 5C-D illustrate front views of the example disposable cover being utilized to cover a monitor (e.g. touch screen), according to one embodiment.

### DETAILED DESCRIPTION OF ILLUSTRATIVE EMBODIMENTS

A system that enables surfaces that individuals may contact often with their hands and that they may eat from to be covered so as to isolate the germs from the surfaces from being contacted by the individual. The main surfaces covered hereby are trays and/or desks that may be used to eat from or work on and possibly touch screens that are utilized to interact with content being presented. It is anticipated that the system will be utilized in places shared by individuals, such as in public transportation (e.g., planes). The system may be reusable, disposable or a combination thereof.

Airplanes are equipped with trays that can be utilized by passengers to hold food or beverages that they are going to eat or drink, hold materials such as a computer, book or the like that they are utilizing for business or pleasure, or to possibly place their head on if they are tired. The trays are typically stored away and can be taken out when the passenger desires to use them. The trays typically either are stored in an armrest of the passenger's seat or on the back of the seat in front of the passenger's seat. The size of the trays may depend on the configuration (e.g., armrest, seat back), the type of airplane and/or the airline. The tray sizes may vary in length (side to side of seat), width (extending away from seat) and possibly thickness. For example, the tray length may vary from approximately 10-18 inches, the tray width may vary from approximately 5-11 inches, and the tray depth may vary from approximately ¼ to ⅝ inch.

According to one embodiment, a tray table cover apparatus is provided that can be secured to the tray in order to cover the tray so that using the tray does not result in the passenger touching the tray which may include germs, contaminants, dirt and the like. The apparatus may be a reusable apparatus that can be used multiple times and in multiple locations. The reusable apparatus may be made from a material or combination of materials that provide at least a subset of a desired list of properties that include being stretchable, washable, antibacterial, durable, water-proof/water-resistant, non-slip, and decorative. One skilled in the art would recognize the types of materials or combination of materials that provide these properties.

An apparatus that is stretchable allows one size apparatus to be utilized with varying size trays/desks. For example, the size of the apparatus may be bigger than the smallest standard size tray utilized in an airplane and be smaller than the largest size tray. When the apparatus is used on a smaller tray it may be wrapped around and secured thereto in some fashion. When the tray is larger than the apparatus, the apparatus may be stretched to fit over the tray and then be secured thereto in some fashion. One skilled in the art would recognize that there are materials that may be (1) stretched in one direction (e.g., along a first axis) often referred to as two way stretch because it can be stretched in either direction along the first axis, and (2) stretched in two directions (e.g., along first and second axes that are perpendicular to each other) often referred to as four way stretch because it can be stretched in either direction along both the first and second axis. One skilled in the art would recognize that stretch fabric is a cloth which has the ability to stretch and may be made partially of elastic fibers such as lycra, elastane, spandex (different names of the same synthetic fiber) or knit fabrics which stretch due to the production method (e.g., looping).

A washable apparatus enables cleaning between uses. The apparatus may be cleaned by wiping it off, scrubbing it in a sink, or washing it in a washing machine. An antimicrobial apparatus may inhibit the ability of microorganisms to grow on the surface thereof. As one skilled in the art would recognize antimicrobial surfaces are functionalized in a variety of different processes including applying a coating that has a chemical compound which is toxic to microorganism, attaching a polymer, or polypeptide, using fabrics with different metals (e.g., silver, copper) that are natural antimicrobial materials that have intrinsic properties to destroy a wide range of microorganisms.

A water-proof/water-resistant apparatus may prevent liquid from, for example a spill, from being absorbed therein where the apparatus then remains wet as it is utilized. Rather, the liquid may pool on the surface and allow for easy clean-up. A non-slip apparatus may prevent items that are placed thereon from sliding and potentially falling off the surface or falling over (e.g., spilling liquid from a glass). A decorative apparatus makes it more aesthetically appealing for the user to look at as they utilize it.

According to one embodiment, the apparatus may be made from a blend of approximately 70% polyester, 20% polyurethane and 10% lycra in order to provide a stretchable (e.g. 4 way) and waterproof apparatus. The apparatus may further include antimicrobial silver fabric to provide antimicrobial properties. For example, the fabric may be a ProSoft® Stretch-Fit Waterproof 1 mil PUL antimicrobial silver fabric with Silvadur by AKAS.

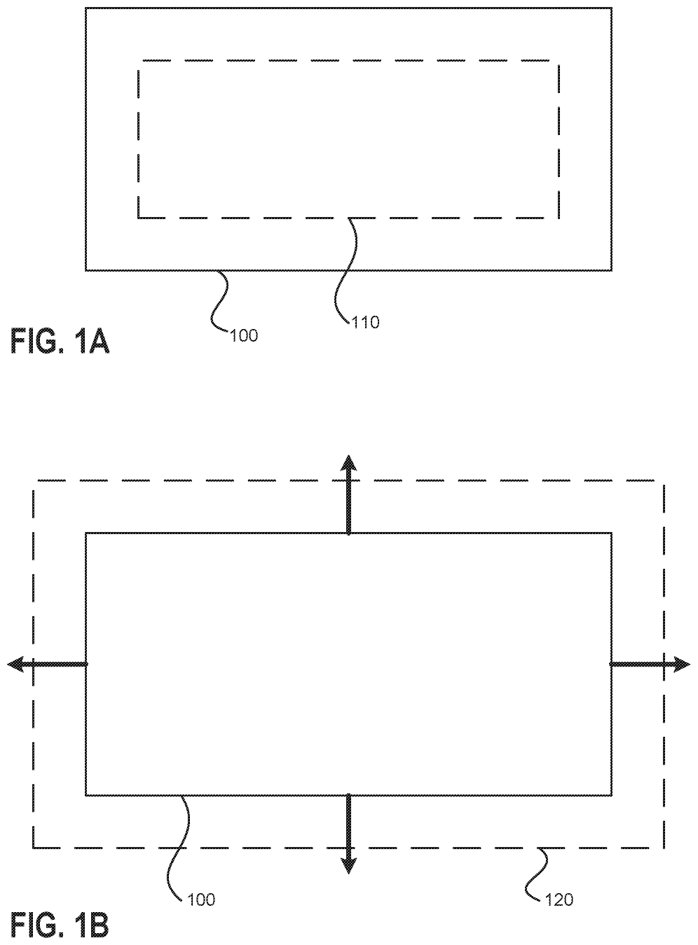

FIGS. 1A-B illustrates an example reusable tray table cover 100 for securing to different size trays. FIG. 1A illustrates a tray 110 that is smaller than the cover 100 when the cover is in a steady state (non-stretched) so that the cover 100 can wrap around the tray 110 and be secured thereto in some fashion (to be discussed in more detail below). The excess material of the cover 100 is illustrated as being equal on each side of the tray 110 but is in no way intended to be limited thereby. For example, the excess material in one direction may be more that the excess material in the other direction or all the excess material could extend from one side for each direction.

FIG. 1B illustrates a tray 120 that is larger than the cover 100 in a non-stretched state so that the cover 100 will need to be stretched in order to cover the tray 120. Once stretched the cover 100 may be secured to the tray 120 in some fashion (to be discussed in more detail below). The cover 100 is illustrated as being short an equal distance on each side so that stretching is required in all directions but is not limited thereto. For example, the shortage on non-extended material in one direction may be more that the shortage of non-extended material in the other direction or all the shortage of non-extended material could be from one side for each direction.

It should be noted that FIGS. 1A-B illustrate the cover 100 either being shorter or longer then the tray 110 or 120 in both directions but is not limited thereto. Rather, the cover 100 dimensions could vary with respect to the tray without departing the current scope (e.g., longer in one direction and shorter in the other, same dimension in one direction and shorter/longer in the other, same dimension in both). The illustrated examples are simply to show that one size cover could be utilized with a wide variety of tray sizes. As noted above, the non-stretched cover size may be selected so as to be between the anticipated largest and smallest tray sizes. In this fashion, the cover can be stretched to fit larger trays and be wrapped (without too much excess material) around smaller trays.

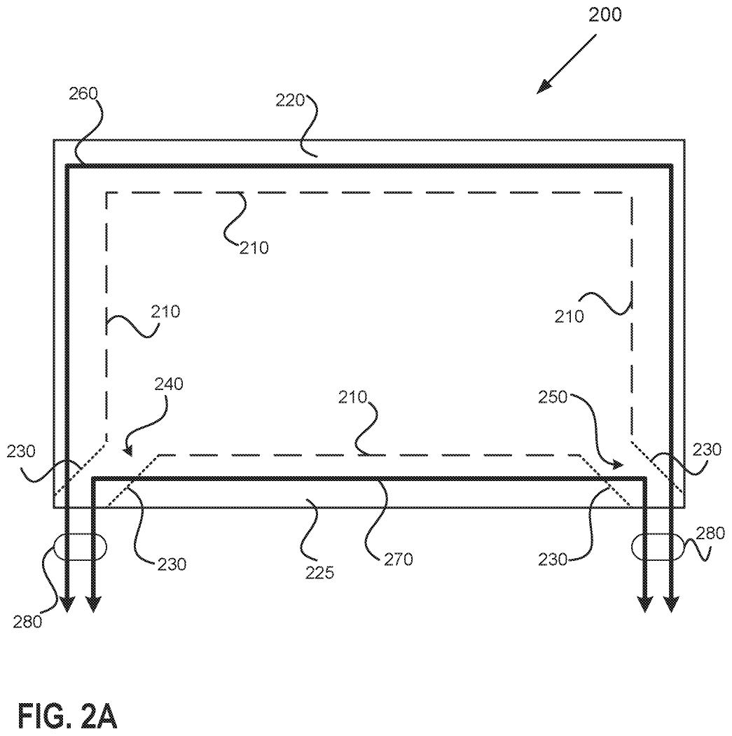

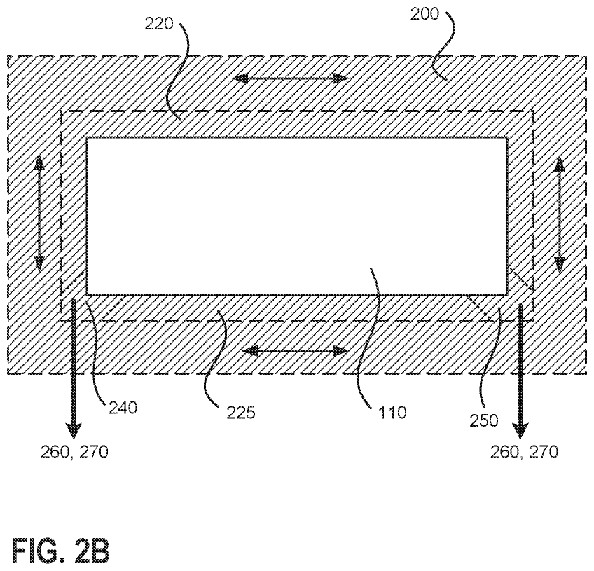

FIG. 2A illustrates a bottom view of an example reusable tray table cover apparatus 200 for securing to a tray in order to prevent a passenger from contacting the tray and the germs, contaminants, dirt and the like that may be located thereon. The apparatus 200 includes material shaped according to its use as a tray cover (e.g., rectangular). Material from each side of the apparatus 200 is folded over and an edge of each side is secured (e.g., stitched) 210 to the material so as to form a channel along an outer perimeter thereof. The folded over portion of each side and the bottom are not secured 230 to the material at each of the lower corners so as to create openings 240, 250. The openings 240, 250 may divide the channel formed along the outer perimeter into a first channel 220 and a second channel 225. The first channel 220 traverses from the first opening 240 to the second opening 250 via the left side, the top and the right side of the apparatus. The second channel 225 traverses from the first opening 240 to the second opening 250 via the bottom.

A first string 260 is routed from the first opening 240 to the second opening 250 via the first channel 220 and a second string 270 is routed from the first opening 240 to the second opening 250 via the second channel 225. The ends of the first and second strings 160, 170 exit the channels via the first and second openings 240, 250. The strings 260, 270 are utilized to contract/retract the apparatus 200 if needed. For example, if the apparatus was larger than the tray it could be placed over the tray and then secured to the tray by pulling the strings 260, 270 which would contract the apparatus 100 around the tray.

The ends of the strings 260, 270 may be secured together in some fashion 280. The securing of the strings 260, 270 is simply illustrated as an oval for ease of illustration. The strings 260, 270 may be secured in various fashions including being tied together or secured in a connector. The securing of the strings 260, 270 prevents the ends of the strings 260, 270 from being pulled in the channels 220, 225. The securing of the strings 260, 270 may also enable the apparatus 200 to be contracted/retracted in both directions by simply pulling the secured strings 280 together.

It should be noted that the openings 240, 250 are illustrated as being on the corners of the bottom edge of the long side of the apparatus 200 but are not limited thereto. Rather, the openings could be at corners of the short side (right or left as illustrated) or could be at diagonal corners without departing from the current scope.

According to one embodiment, each side of the strings 260, 270 (sides exiting the openings 240, 250) are pulled together to tighten the cover from each side. However, in certain situations or to make certain adjustments the strings may be pulled from a single side. In order to loosen the cover 200 after the strings 260, 270 have been used to secure the cover 200 to a tray, the contracted portions of the cover 200 will be stretched apart (e.g., pulled away from the openings 240, 250 in appropriate directions).

The cover 200 will have a steady state non-stretched size. If the cover 200 is larger than a tray it is being placed on in both directions such as that illustrated in FIG. 1A, the user may place the cover 200 over the tray so that the cover 200 extends over each edge of the tray. The user may then pull the strings 260, 270 so that the portions of the cover 200 extending passed the tray is retracted in each direction and the excess material is gathered under the tray so that the cover 200 is secured to the tray.

FIG. 2B illustrates a bottom view of the cover 200 secured to the tray 110 that is smaller than the cover 200. As illustrated, the cover 200 is wrapped around the edges of the tray 110 and is secured to the tray 110 by pulling the strings 260, 270 (only portion of strings extending from openings 240, 250 are illustrated and are illustrated as a single arrow for ease of illustration) which retracts the channels 220, 225 and pulls the excess material tight around the tray 110. As illustrated, the channels 220, 225 and other portions of cover 200 that are retracted (gathered) are shown cross-hatched. To remove the cover 200, the user would pull the gathered material (cross hatched) apart in all directions (e.g., for the first channel 220 away from the openings 240, 250 on the sides and toward the sides along a top edge, for the second channel toward the openings 240, 250).

If the cover 200 is larger than the tray in a first direction and shorter than the tray in a second direction, the cover 200 should be placed on the tray so that the excess cover in the first direction extends over each respective edge of the tray. The cover 200 should then be stretched in the other direction so that the cover extends toward the respective edge(s), and possibly extends over the respective edge(s) of tray. The strings 260, 270 are then pulled to gather the excess material in the first direction and to secure the cover 200 to the tray with the cover 200 in a stretched configuration in the second direction. To remove the cover 200, the user would pull the gathered material apart in the respective direction (e.g., sides, top/bottom).

If the cover 200 is shorter than the tray in both directions such as that illustrated in FIG. 1A, the cover 200 should be placed on the tray and stretched so that the cover extends toward the respective edge(s), and possibly extends over at least an opposite set of edges of the tray. The strings 260, 270 are then pulled to secure the cover 200 to the tray with the cover 200 in a stretched configuration in both directions. If the cover 200 cannot be stretched so as to extend over the edges of the tray in at least one direction, the strings 260, 270 likely will not be helpful in securing the cover 200 to the tray.

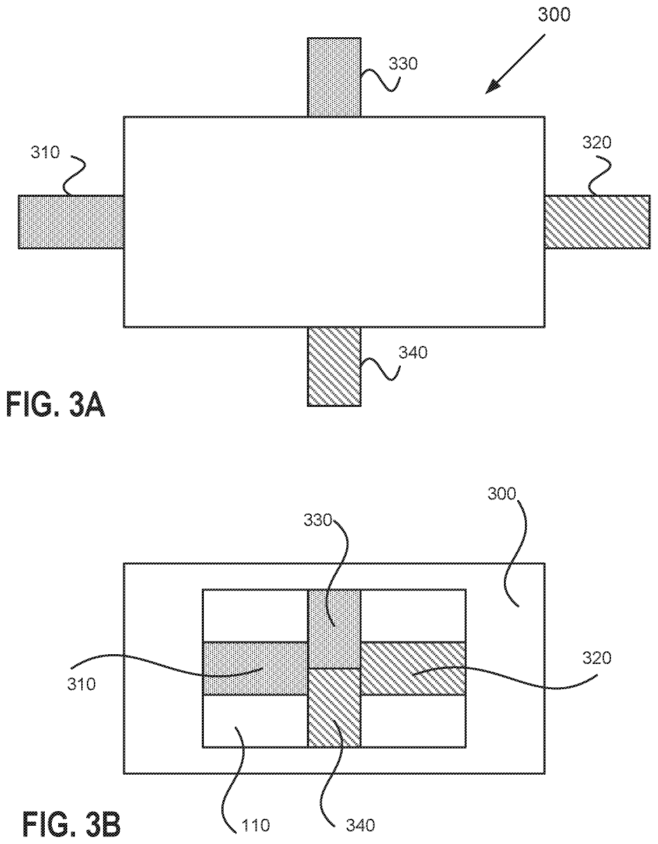

FIG. 3A illustrates an example reusable tray table cover apparatus 300. The apparatus 300 includes material shaped according to its use as a tray cover (e.g., rectangular). Extending from at least one pair of opposite sides of the apparatus 300 is at least one hook and loop connector (e.g., Velcre). As illustrated, a hook connector 310 is located on a left side and a corresponding loop connector 320 is located on a right side in alignment therewith. A hook connector 330 is located on a top side and a corresponding loop connector 340 is located on a bottom side in alignment therewith. The corresponding hook/loop connectors 310/320, 330/340 may be sized to secure the apparatus 300 below the tray for various size trays.

As with the cover 200, the cover 300 may have a non-stretchable size that is smaller or larger than the tray it is secured to in either direction. If the tray is smaller, the excess material is wrapped around the tray and is then secured thereto with the appropriate hook/loop connectors 310/320, 330/340. If the tray is larger, the apparatus is stretched in the appropriate direction(s) and is then secured to the tray with the appropriate hook/loop connectors 310/320, 330/340. It should be noted that the number and location of the hook/loop connectors is not limited to those illustrated.

FIG. 3B illustrates a bottom view of the cover 300 secured to the tray 110 that is smaller than the cover 300. As illustrated, the cover 300 is wrapped around each of the edges of the tray 110 and is secured to the tray 110 by securing the appropriate hook/loop connectors 310/320, 330/340 together. To remove the cover 300, the user would detach the appropriate hook/loop connectors 310/320, 330/340 from each other.

According to one embodiment, other types of connectors may be utilized in place of the hook/loop connectors. For example, corresponding straps having an adjustable connector (e.g., buckle) on one side to enable the straps to be tightened or loosened as need be. Alternatively, one side of the corresponding straps may include a plurality of nubs and the other side may include a plurality of receptacles that may be connected in different arrangements depending on the size of the tray.

The tray covers to this point have been described as being a generally flat surface that is placed on the tray and secured thereto in some fashion. According to one embodiment, a tray cover may be designed as a sleeve that is placed over a tray. The sleeve may have open sides that can be slid over the tray from left to right (or right to left) or may have an open top and bottom that can be slid over the tray from top to bottom (or bottom to top). A sleeve that slides over the sides, may include approximately twice the amount of material as utilized for a flat cover from top to bottom. The material may be looped back upon itself and secured together along top and bottom edges so that the sides are open. Likewise, a sleeve that slides over the top/bottom, may include approximately twice the amount of material as utilized for a flat cover from side to side. The material may be looped back upon itself and secured together along sides so that the top and bottom are open The dimensions of the cover sleeve may depend on the size variation of the trays it is to be used on.

If the opening in a cover loop is smaller than the tray the cover loop may be stretched so as to fit on the tray. However, if the opening in the cover loop is larger than the tray the cover loop may not be secure around the tray. Accordingly, the cover loop may include a means to tighten the cover loop on the tray. The means for tightening may include Velcro, straps, buckles or the like. The various means may be arranged in various fashions without departing from the scope. Likewise, if the length (or width) of the cover loop is smaller than the length (or width) of the tray the cover loop may be stretched so as to cover the tray. However, if the length (or width) of the cover loop is larger than the length (or width) of the tray the cover loop may extend past the sides (e.g., left/right, top/bottom) of the tray. According to one embodiment, the cover loop may include a means to secure the excess cover loop, for example, under the tray. The means for securing may include Velcro, straps, buckles or the like. The various means may be arranged in various fashions without departing from the scope.

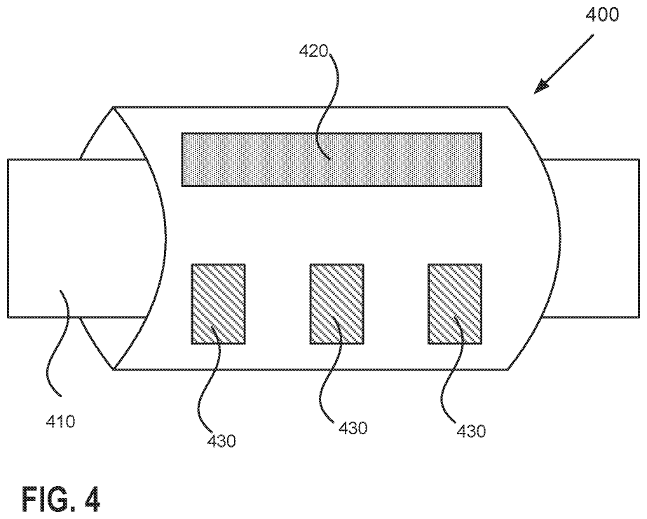

FIG. 4 illustrates a bottom view of an example cover loop 400 apparatus being placed over a tray 410. As illustrated, the cover loop 400 is shorter than the tray 410 (tray 410 extends from each side) but is wider than the tray 410 (top and bottom of the cover loop 400 do not engage the tray 410). The cover loop 400 includes a hook connector 420 traversing from side to side and a plurality of loop connectors 430 traversing up and down at different locations along the length. If the cover loop 400 is too loose on the tray 410 the loop 400 may be folded to reduce the size and the reduced size may be secured by engaging the hook connector 420 with the loop connectors 430. It should be noted that the number and arrangement of hook and loop connectors 420, 430 is in no way intended to be limited to those illustrated. It should also be noted that a similar arrangement could be utilized to shorten the length of the loop 400.

The tray covers to this point have been described as being reusable. According to one embodiment, the tray covers may be disposable. Disposable covers are meant to be used once and then thrown away. A disposable cover may be made from a film that is stretchable and can cling to a surface without the use of glue or the like that would leave a residue on the try after use. According to one embodiment, the film may also be water-proof/water-resistant and have antimicrobial properties.

One skilled in the art would recognize that films may cling to surfaces as soon as they are applied, may only cling after they are stretched to activate the clinging properties, or may require some type of pressure (e.g., rubbing the film after it is applied) to activate the clinging. These films may be released from the surfaces by simply applying pressure or in some cases pulling in a specific direction. While the films may be capable of stretching, their ability to stretch is not the same as the fabrics (e.g., spandex) described above foe the reusable cover. Accordingly, one size disposable film may not be capable of being used for all trays. Rather, disposable covers may come in a few different sizes (e.g., large, small) that can be used for different size (e.g., large, small) trays.

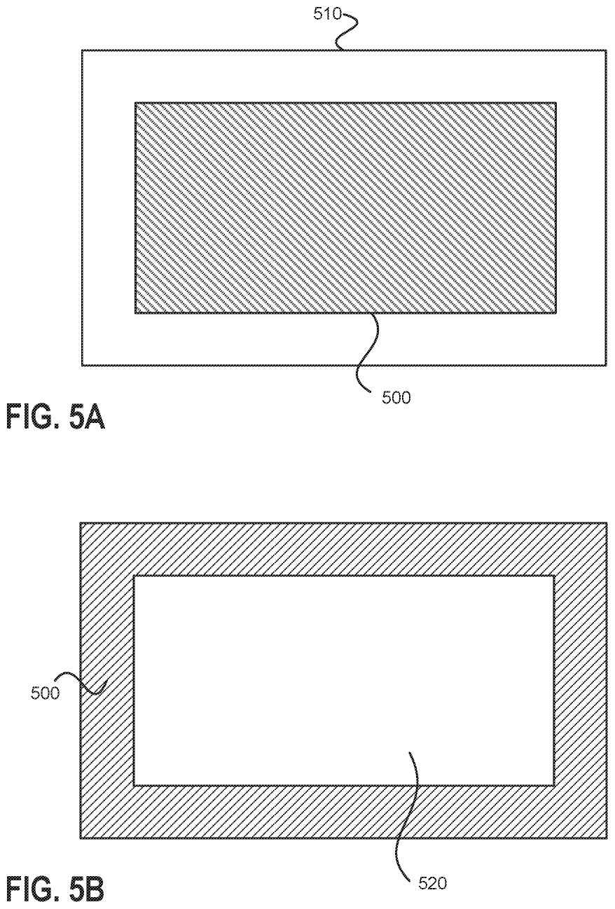

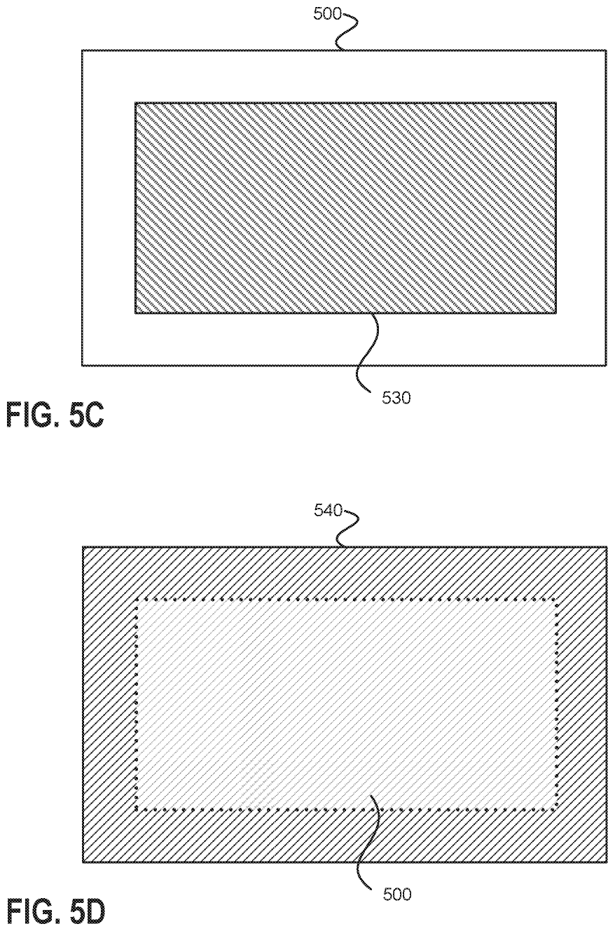

FIGS. 5A-B illustrate top and bottom views of an example disposable tray table cover 500. FIG. 5A illustrates a top view where the cover 500 stretched to activate the clinging is smaller than a tray 510 it is located on. According to one embodiment, the cover 500 is sized to cover substantially the entire top surface of the tray 510 when expanded as larger size covers would be used for larger size trays. FIG. 5B illustrates a bottom view where the cover 500 stretched to activate the clinging is larger than a tray 520 it is located on and the excess cover 500 is secured below the tray 520.

It should also be noted that the disposable film cover may also be used to cover the monitor (e.g., touch screen monitor) that are often found on the seat back of the seat in front of a passenger on a plane. A disposable cover for the monitor may be included as part of a system that includes a reusable tray cover and/or a disposable tray cover.

FIGS. 5C-D illustrate front views of the example disposable cover 500 being utilized to cover a monitor (e.g. touch screen). FIG. 5C illustrates the cover 500 being used on a monitor 530 that is smaller than the cover 500 so the cover 500 extends past the edges of the monitor 530 and is secured to the seat back that the monitor 530 is located in. FIG. 5D illustrates the cover 500 being used on a monitor 540 that is larger than the cover 500 so the cover 500 only covers a majority of the monitor 540 and is secured to the monitor 540.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A cover to be secured to a surface to isolate germs located on the surface from a user of the surface, the cover comprising:
a main body generally shaped same as a shape of the surface, wherein the main body is sized between different sizes associated with standard surfaces, wherein the main body is capable of being stretched along at least one axis thereof so as to cover a variety of different sized surfaces; and
means for securing the main body to the surface.

2. The cover of claim 1, wherein the main body includes at least one channel formed around a perimeter thereof, and the means includes at least on string routed through the at least one channel.

3. The cover of claim 2, wherein the main body is secured around the surface by pulling the string.

4. The cover of claim 1, wherein the main body includes a channel formed around a perimeter thereof, wherein the channel includes two openings, and the means includes a first string routed between the two openings via a first path and a second string routed between the two openings via a second path.

5. The cover of claim 4, wherein the main body is secured around the surface by pulling the first and the second strings.

6. The cover of claim 1, wherein the means includes at least one fastener having aligned parts extending from opposite edges thereof.

7. The cover of claim 6, wherein the at least one fastener is a Velcro® fastener.

8. The cover of claim 1, wherein the cover is reusable.

9. The cover of claim 8, wherein the main body is made from a plurality of materials that provide desired characteristics.

10. The cover of claim 9, wherein the desired characteristics include at least a subset of stretchable, washable, antibacterial, durable, water-proof/water-resistant, non-slip, and decorative.

11. The cover of claim 9, wherein the plurality of materials includes approximately 70% polyester, 20% polyurethane and 10% lycra.

12. The cover of claim 9, wherein the plurality of materials includes silver fibers to provide antimicrobial properties.

13. The cover of claim 1, wherein the cover is disposable.

14. The cover of claim 13, wherein the main body is made from a film that can be secured to the surface.

15. The cover of claim 1, wherein the surface is a tray.

16. The cover of claim 15, wherein the tray is located in an airplane.

17. A system for isolating usable surfaces in an airplane to isolate germs located on the surfaces from a passenger, the system comprising:
a tray cover including a main body generally shaped same as a shape of a tray, wherein the main body is sized between different sizes associated with standard trays, wherein the main body is capable of being stretched along at least one axis thereof so as to cover a variety of different sized trays; and means for securing the main body to the tray.

18. The system of claim 17, wherein
the tray cover is reusable; and the main body is made from a plurality of materials that provide at least a subset of stretchable, washable, antibacterial, durable, water-proof/water-resistant, and non-slip properties.

19. The system of claim 17, wherein the tray cover is disposable.

20. The system of claim 17, further comprising a monitor cover that is disposable.
